(19) United States
(12) Patent Application Publication
(10) Pub. No.: US 2005/0161947 A1
(43) Pub. Date: Jul. 28, 2005

(54) Sealing system for pipelines

(76) Inventors: James W. Skinner, Fort Wayne, IN (US); Bryan N. Zeigler, Fort Wayne, IN (US); Paul S. Pennell, Fort Wayne, IN (US)

Correspondence Address: BAKER & DANIELS LLP;111 E. WAYNE STREET, SUITE 800, FORT WAYNE, IN, 46802, US

(21) Appl. No.: 10/857,810

(22) Filed: Jun. 1, 2004

Related U.S. Application Data
(60) Provisional application No. 60/515,563, filed on Oct. 28, 2003.

(51) Int. Cl. F16L 21/00

(52) U.S. Cl. 285/374; 285/903

(57) ABSTRACT

A sealing system for pipes, which is particularly applicable for corrugated pipes of the type including a corrugated pipe section having spigot end and a bell end including an annular bell ring. A gasket is attached to the open end of the bell ring at the bell end of the pipe, the gasket including an external portion and an internal portion. The external portion of the gasket is attached to the bell ring with a clamping band, for example, and the internal portion of the gasket is disposed inside of the bell ring and includes one or more sealing projections which project internally of the bell ring. Upon insertion of an end of a first corrugated pipe into the bell ring of a second corrugated pipe which includes the gasket, the sealing projections of the gasket engage one or more of the corrugations of the first pipe, and deformingly compress between the corrugations of the first pipe and the bell ring of the second pipe to provide a watertight seal.

### CROSS REFERENCE TO RELATED APPLICATIONS

This application claims the benefit under Title 35, U.S.C. § 119(e) of U.S. Provisional Patent Application Ser. No. 60/515,563, entitled SEALING SYSTEM FOR PIPELINES, filed on Oct. 28, 2003.

### BACKGROUND OF THE INVENTION

1. Field of the Invention

The present invention relates to sealing systems for sealing pipes to one another in an end-to-end manner in underground pipelines. The present invention is particularly applicable to sealing corrugated pipes to one another.

2. Description of the Related Art

Corrugated pipes for underground pipelines, such as those which are used in municipal sanitary sewer systems and/or storm sewer systems, for example, are typically made of two layers. An outer layer of each pipe forms the outer surface of the pipe, and defines a plurality of annular ridges or corrugations. An annular inner or liner layer of the pipe is attached to the outer layer in a suitable manner, such as by heat welding, and defines a smooth, cylindrical inner surface of the pipe.

Typically, these pipes are manufactured to a standard length. Referring to FIG. 1, a known pipe 20 generally includes an outer surface defined by a plurality of annular corrugations 22 defining peaks and valleys therebetween, and a smooth inner surface 24. Pipe 20 additionally includes spigot end 26, which may include one or more corrugations of reduced diameter in relation to the remainder of the corrugations 22. Spigot end 26 includes an annular, resilient gasket or seal 28 therearound, which is stretched over and around the spigot end 26 and clamped onto one or more of the corrugations of spigot end 26 by a metal clamping band 30. In this manner, gasket 28 is disposed externally of pipe 20 around spigot end 26 of pipe 20. Alternatively, other known external gaskets for spigot end 26 may be disposed within one or more of the valleys between successive peaks of the corrugations at spigot end 26 of pipe 20.

Bell end 32 of pipe 20 includes an annular plastic bell ring 34, which is typically heat welded to an endmost corrugation 22 of pipe 20. To connect two pipes 20 to one another in an end-to-end manner, the spigot end 26 of a first pipe 20 is inserted into the bell end 32 of a second pipe 20, with gasket 28 of the first pipe 20 contacting the inner surface 36 of bell ring 34 of the second pipe 20. Upon contact of gasket 28 with the inner surface 36 of bell ring 34, gasket 28 is compressed between spigot end 26 of the first pipe 20 and the inner surface 36 of bell ring 34 of the second pipe 20 to form a watertight seal between the first and second pipes 20.

A problem with the foregoing arrangement is that in many field applications, lengths of pipe are needed which are less than the standard pipe length. For example, when a pipeline is connected to a concrete structure such as a manhole riser or any other fixed location within an underground pipe system, a pipe of a shorter length than the standard length may be needed at the connection point. In this instance, a standard length pipe is typically cut in the field along a cut line such as line L₁-L₁ of FIG. 1, for example, from the spigot end 26 of pipe 20 to form a pipe of the desired length. Typically, bell end 32 of the pipe 20 remains intact. However, referring to FIG. 2, a new external gasket 28 must be stretched and fitted around the cut end 38 of the reduced length pipe 20, which is a difficult, tedious, and time consuming procedure in the field. Thereafter, a metal clamping band 30 is secured around gasket 28 to clamp gasket 28 to the cut end 38 of pipe 20.

Another problem with the foregoing arrangement is that the foregoing types of “field installed” gaskets could potentially move from their installed location longitudinally along pipe 20, such as when the cut end 38 of a first pipe 20 with a field-installed gasket 28 is inserted into the bell end 32 of a second pipe and the gasket 28 frictionally contacts the inner surface 36 of bell end 32. Additionally, internal pressure within the pipeline could potentially cause bell ring 34 to flex, bend, or flare outwardly, potentially leading to a failure of the seal between gasket 28 and bell ring 34.

Further, the dimensions and tolerances of pipes 20, gaskets 28 and bell rings 34 may vary from manufacturer to manufacturer. Thus, a contractor installing a pipeline in the field, for example, is often restricted to using only the particular pipeline components which are produced by a single manufacturer.

What is needed is a sealing system for pipes, and in particular, a sealing system for corrugated pipes, which is an improvement over the foregoing.

### SUMMARY OF THE INVENTION

The present invention provides a sealing system for pipes, which is particularly applicable for corrugated pipes of the type including a corrugated pipe section having spigot end and a bell end including an annular bell ring. A gasket is attached to the open end of the bell ring at the bell end of the pipe, the gasket including an external portion and an internal portion. The external portion of the gasket is attached to the bell ring with a clamping band, for example, and the internal portion of the gasket is disposed inside of the bell ring and includes one or more sealing projections which project internally of the bell ring. Upon insertion of an end of a first corrugated pipe into the bell ring of a second corrugated pipe which includes the gasket, the sealing projections of the gasket engage one or more of the corrugations of the first pipe, and deformingly compress between the corrugations of the first pipe and the bell ring of the second pipe to provide a watertight seal.

Advantageously, the present gasket eliminates the need for known types of external gaskets which are attached externally around the spigot end of a corrugated pipe. For example, in known corrugated pipe sealing systems, when the need for a pipe arises which is shorter than a standard length, the pipe is cut from the spigot end, and a new external gasket is installed to the cut pipe end in the field, which is a difficult and time-consuming process. By contrast, the present gasket is easily installed onto the end of the bell ring at the bell end of a pipe with minimal stretching of the gasket, and the gasket is secured to the bell end with a clamping band to provide a watertight seal with the corrugated spigot end of another pipe. Thus, if a pipe shorter than the standard length is needed, the pipe may be cut from either the bell end or the spigot end as desired. A new bell ring may be easily welded to a pipe section in the field, and the present gasket is easily attachable to the bell ring either before or after the bell ring is welded to the corrugated pipe section.

Further, the clamping band serves to hold the gasket onto the bell ring, and also provides increased rigidity to the bell ring. In this manner, the clamping band aids in rigidly maintaining the shape of the bell ring under internal pipe pressures, thereby preventing bending, flexing, or bowing of the bell ring which could potentially lead to movement or deformation of the gasket and failure of the seal.

In one form thereof, the present invention provides a pipe assembly, including a first pipe section having an end portion including an annular wall with an open end; an annular gasket positioned over the open end of the annular wall, the gasket including an external portion disposed on an exterior side of the annular wall, the external portion including at least one clamping band seat; and an internal portion disposed on an interior side of the annular wall, the internal portion including at least one sealing projection.

In another form thereof, the present invention provides a pipe assembly, including a first pipe section having a plurality of corrugations defining alternating peaks and valleys and an end portion including an annular wall with an open end; an annular gasket positioned over the open end of the annular wall, the gasket including an external portion disposed on an exterior side of the annular wall, the external portion including at least one clamping band seat; and an internal portion disposed on an interior side of the annular wall, the internal portion including at least one sealing projection; and an annular clamping band positioned within the clamping band seat around the external portion of the gasket, the external portion of the gasket compressed between the clamping band and the annular wall.

In a further form thereof, the present invention provides, in combination, a first pipe section having an end portion including an annular wall with an open end, and an annular gasket positioned over the open end of the annular wall, the gasket including an external portion disposed on an exterior side of the annular wall; and an internal portion disposed on an interior side of the annular wall, the internal portion including at least one sealing projection; and a second pipe section having an end portion inserted within the annular gasket, the at least one sealing projection of the gasket compressed between the end portion of the second pipe section and the annular wall of the first pipe section.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of a known pipe, including a spigot end having an external annular gasket, and a bell end including a bell ring;

FIG. 2 is a partial perspective view of a cut end of the pipe of FIG. 1, cut along cut line L₁-L₁ of FIG. 1, further showing an annular external gasket and a metal clamping band in exploded view;

FIG. 3 is a perspective view showing two pipes incorporating the sealing system of the present invention, one of the pipes including a bell end having a bell ring, and a gasket according to a first embodiment of the present invention attached to the bell ring;

FIG. 4 is a sectional view taken along line 4-4 of FIG. 3;

FIG. 5 is a sectional view similar to that of FIG. 4, showing the sealing connection between a pair of pipes which is provided by the gasket;

FIG. 6 is a perspective exploded view showing a length of pipe, a bell ring, the gasket according to the first embodiment, and a metal clamping band;

FIG. 7 is a sectional view of the bell end of a pipe including a gasket according to a second embodiment; and

FIG. 8 is a sectional view showing the sealing connection between a pair of pipes which is provided by the gasket of FIG. 7.

Corresponding reference characters indicate corresponding parts throughout the several views. The exemplifications set out herein illustrate preferred embodiments of the invention, and such exemplifications are not to be construed as limiting the scope of the invention any manner.

### DETAILED DESCRIPTION

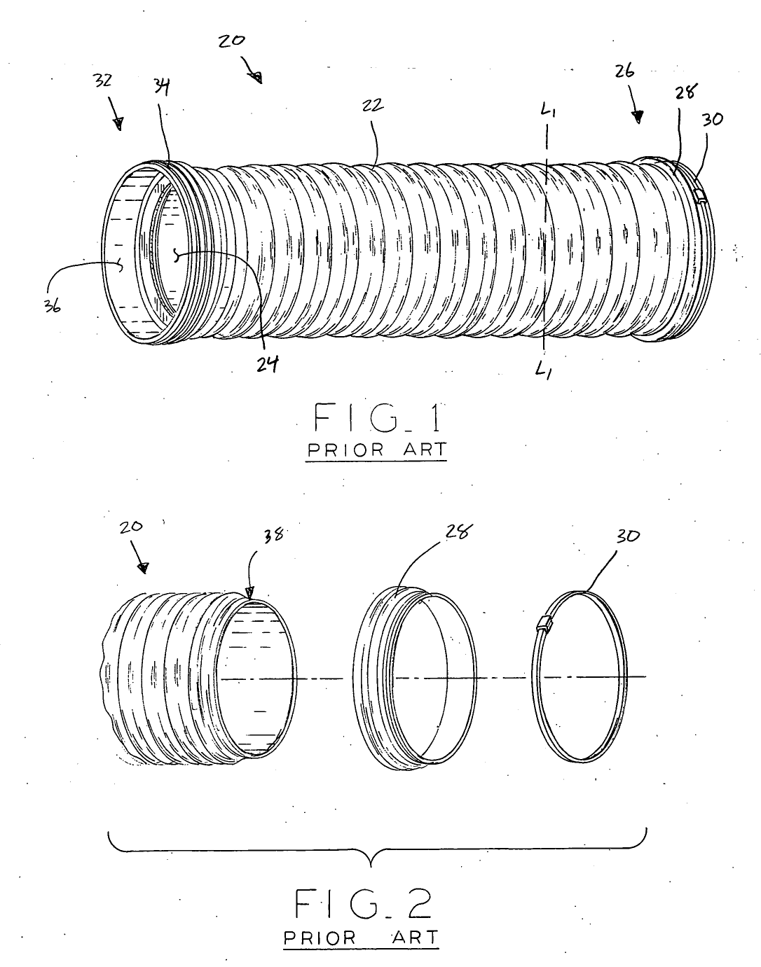

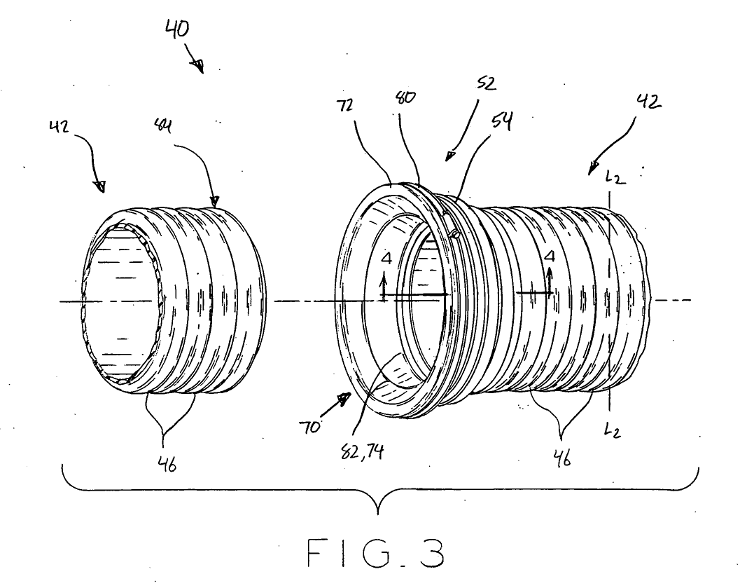

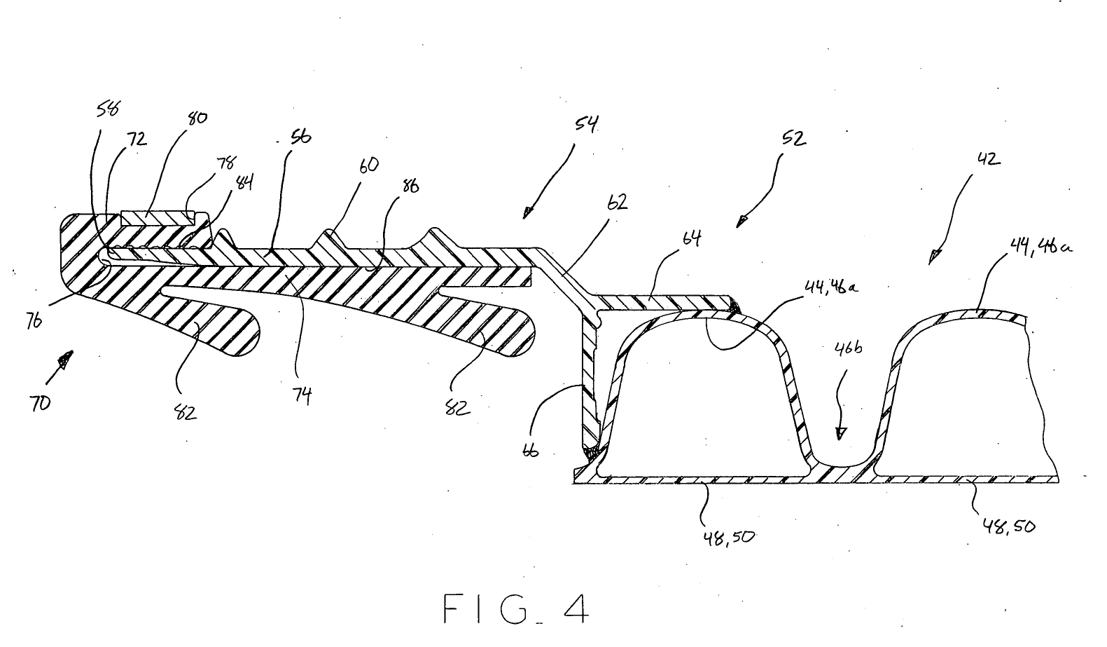

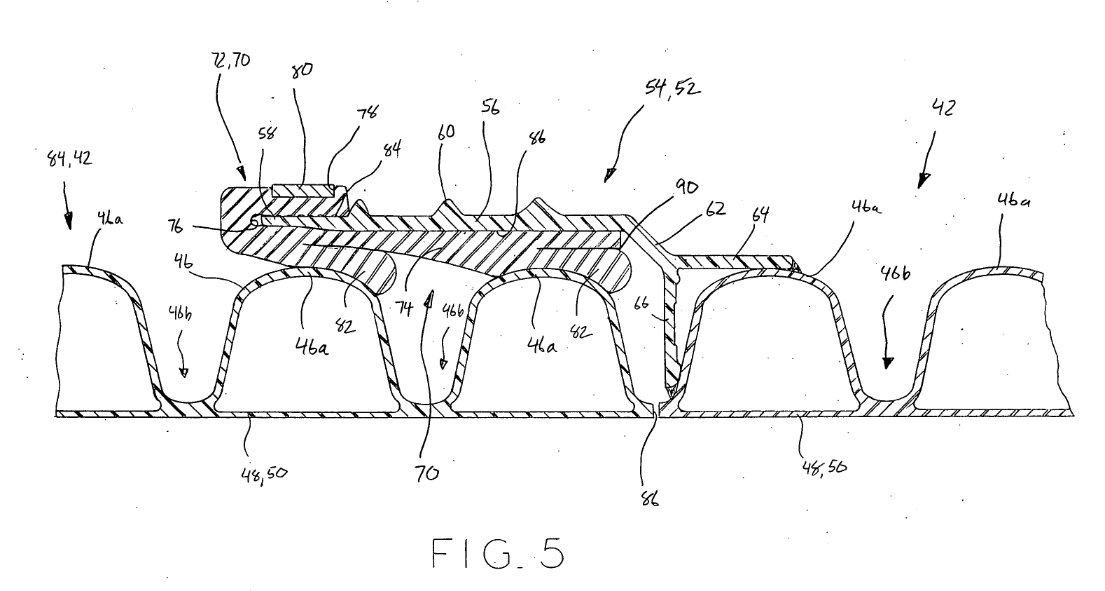

Referring to FIG. 3, sealing system 40 for pipes 42 is shown according to the present invention. Pipes 42 are similar to those shown in FIGS. 1 and 2, and each include, with additional reference to FIG. 4, a plastic outer layer 44 defining a plurality of corrugations 46 with peaks 46a and valleys 46b, and a plastic inner or liner layer 48 defining a smooth inner surface 50 of pipe 42. If Inner layer 48 is not integrally molded with outer layer 44, inner layer 48 may be attached to outer layer 44 in a suitable manner, such as by heat welding. Pipes are typically made of a rigid plastic material, such as high density polyethylene, for example, or alternatively, may be made of a suitable metal such as galvanized aluminum, for example.

Bell end 52 of pipes 42, which is shown in cross section in FIG. 4, generally includes an annular plastic bell ring 54 with main wall 56 having outer end 58 and a plurality of external annular ridges 60 therearound. Annular ridges 60 provide rigidity to bell ring 54 to resist flexing, bending, or outward flaring of bell ring 54 under internal pipe pressures. Bell ring 54 additionally includes a radially sloped transition section 62 connected to first and second attachment walls 64 and 66 which are disposed perpendicular to one another. As shown in FIG. 4, first and second attachment walls 64 and 66 are rigidly attached to an endmost corrugation 46 of a length of pipe 42 in a suitable manner, such as by heat welding or by an adhesive, for example.

Gasket 70 according to the present invention is secured to outer end 58 of bell ring 54 as shown in FIGS. 3 and 4. Gasket 70 is made from a resilient, compressible material such as a natural or synthetic rubber compound or a thermoplastic material, for example. Gasket 70 generally includes external portion 72 disposed externally of bell ring 54, and internal portion 74 disposed internally of bell ring 54. A slot 76 is defined between external portion 72 and internal portion 74, in which outer end 58 of bell ring 54 is received, as described below. External portion 72 includes at least one clamping band seat or recess 78 therein which is dimensioned to fittingly receive a clamping band 80. Internal portion 74 includes at least one annular lobe-like sealing projection 82 which projects or extends radially inwardly from internal portion 74. Gasket 70, shown in FIGS. 3 and 4, includes a pair of sealing projections 82; however, the number and shape of sealing projections 82 may vary.

To attach gasket 70 to bell ring 54, gasket 70 is placed over open end 58 of bell ring 54, with open end 58 and a portion of main wall 56 of bell ring 54 received within slot 76 of gasket 70. In this position, external portion 74 of gasket 70 abuts, or is disposed proximate, the outer surface 84 of bell ring 54, and internal portion 74 abuts, or is disposed proximate, the inner surface 86 of bell ring 54. Gasket 70 is dimensioned with respect to bell ring 54 such that only very minimal stretching of gasket 70 is required in placing gasket 70 over open end 58 of bell ring 54. In this manner, gasket 70 is easily attached to bell ring 54. Thereafter, clamping band 80 is positioned within recess 78 around external portion 72 of gasket 70, and is then tightened in a suitable manner to securely clamp external portion 72 of gasket 70 firmly against outer surface 84 of main wall 56 of bell ring 54. Clamping band 80 is typically made of stainless steel, but may also be made of plastic or other suitable material. Gasket 70 may be attached to bell ring 54 in the above-described manner either before or after bell ring 54 is connected to pipe 42.

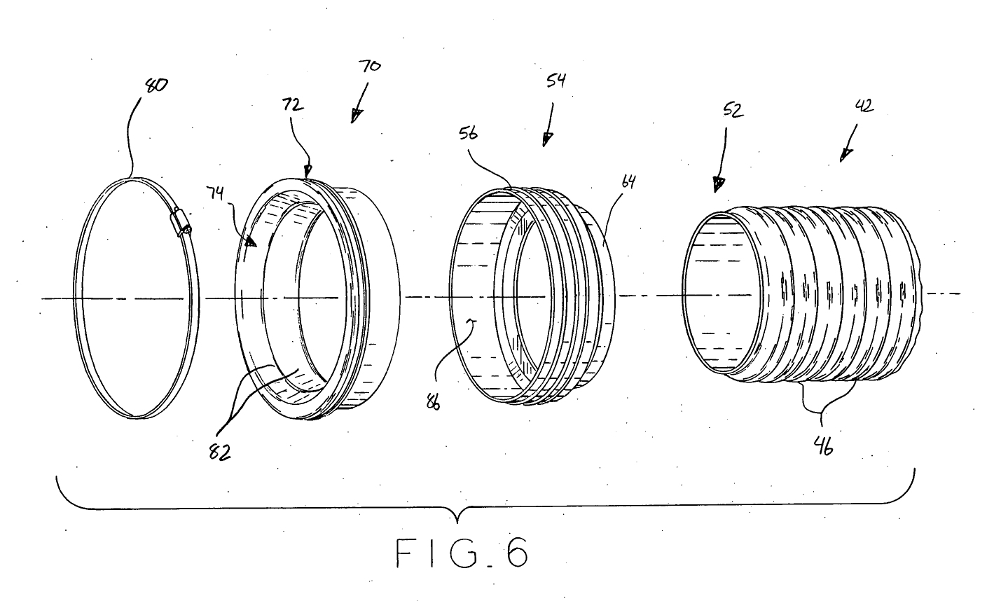

Referring to FIGS. 3 and 5, spigot end 84 of pipe 42 may lack an external gasket, having only corrugations 46. Using gasket 70 of the present invention, a sealing connection may be provided between a pair of pipes 42 by inserting the spigot end 84 of one pipe into bell ring 54 at the bell end 52 of another pipe 42 which includes gasket 70. Referring to FIG. 5, upon insertion of spigot end 84 of one pipe 42 into bell ring 54 of another pipe 42, the two endmost corrugations 46 of the spigot end 84 engage respective sealing projections 82 of internal portion 74 of gasket 70, thereby compressing and/or deforming sealing projections 82 between the peaks 46b of the endmost corrugations 46 and internal portion 74 of gasket 70 to provide a watertight seal between bell ring 54 and each of the endmost corrugations 46. In this manner, a watertight seal is provided between the two connected pipes 42.

Upon insertion of spigot end 84 of one pipe 42 into bell ring 54 of another pipe 42 as shown in FIG. 5, a small gap 86 is typically present between spigot end 84 of the first pipe 42 and bell end 52 of the other pipe 42, such that fluid pressure may build between spigot end 84 and bell ring 54. However, leakage of fluid from the joined pipes 42 is prevented by each of the watertight seals provided by first and second sealing projections 82 of gasket 70. Also, in the event fluid pressure builds in a gap area 90 between internal portion 74 and sealing projection 82 of gasket 70, the fluid pressure will tend to force sealing projection 82 away form internal portion 74 of gasket 70, thereby further compressing sealing projection 82 against its abutted corrugation 46 of the first pipe 42 and increasing the integrity of the watertight seal between the pipes 42 which is provided by gasket 70.

In addition to attaching gasket 70 to bell ring 54, clamping band 80 also provides rigidity to main wall 56 of bell ring 54 in order to prevent main wall 56 of bell ring 54 from flexing, bending, or flaring radially outwardly under the influence of internal pressures within the pipes 42. In this manner, clamping band 80 rigidly maintains the shape of bell ring 54 as shown in FIG. 5 under the influence of internal pressures within pipes 42, thereby preserving the integrity of the watertight seals which are provided by first and second sealing projections 82 of gasket 70.

Optionally, pipes 42 may be produced at a factory, for example, in the manner shown in FIG. 6, in which bell ring 54 is connected to bell end 52 of pipe 42, such as by heat welding, followed by the attachment of gasket 70 and clamping band 80 to bell ring 54 in the manner described above. Alternatively, gasket 70 and clamping band 80 may be attached to bell ring 54 before bell ring 54 is connected to bell end 52 of pipe 42. Advantageously, with the present gasket 70, known types of external gaskets of the type attached to spigot end 84 of pipe 42 and shown in FIGS. 1 and 2 are not needed, thus greatly simplifying the construction of each pipe 42. Pipes 42 may be attached to one another in the field in the manner described above to construct a watertight pipeline. Optionally, the present gasket 70, when attached to bell ring 54 at the bell end 52 of a pipe 42, may also sealingly receive the existing spigot ends of known pipes which include an external gasket 28 of the type shown in FIG. 1.

When pipes 42 of a shorter length than a standard length of pipe 42 are needed, pipes 42 is cut along cut line L₂-L₂ (FIG. 3) from bell end 52, thereby removing bell end 52 from pipe 42. Alternatively, pipe 42 may be cut from spigot end 84 of pipe 42. Thereafter, a new bell ring 54 may be connected to the cut end of pipe 42 in the field, followed by attachment of gasket 70 and clamping band 80 thereto in the manner described above. Alternatively, gasket 70 and clamping band 80 may be attached to bell ring 54 before bell ring 54 is attached to the cut end of pipe 42. For example, a contractor may wish to have several bell rings 54 with attached gaskets 70 available in the field during installation of an underground pipeline, such that when short length pipes are needed, standard length pipes may be easily cut in the manner described above, followed by connecting bell ring 54 and gasket 70 thereto.

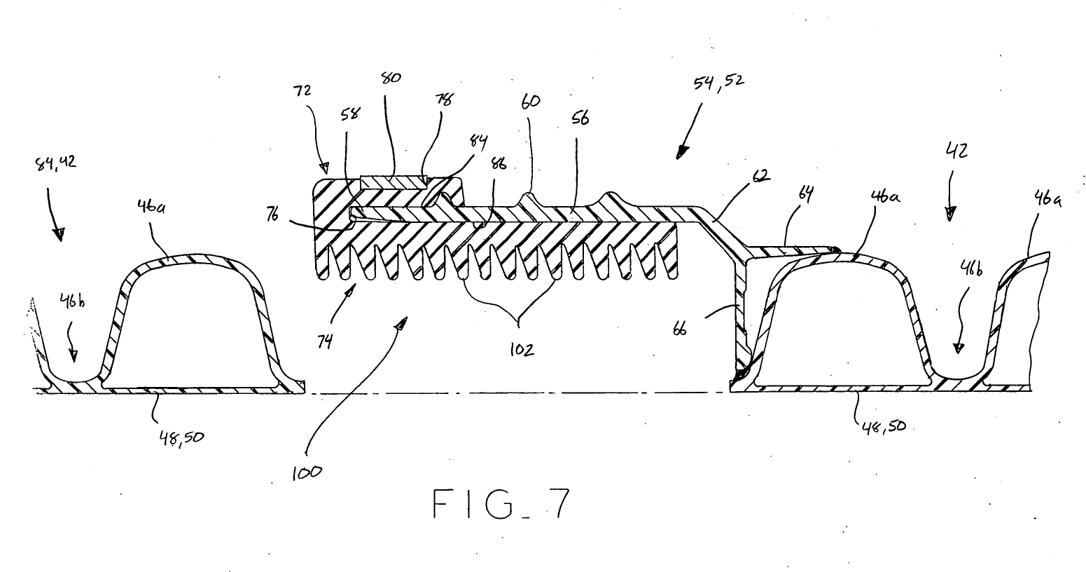

Referring to FIG. 7 gasket 100 is shown according to a second embodiment. Gasket 100 includes many features which are identical to those of gasket 70 described above, and the same reference numerals are used to indicate identical features therebetween. Rather than including a pair of sealing projections 82 however, gasket 100 includes a series of annular sealing ridges 102 projecting radially from internal portion 74 of gasket 100 into the interior of bell ring 54. Gasket 100 may be attached to bell ring 54 using clamping band 80 in the same manner as described above with respect to gasket 70.

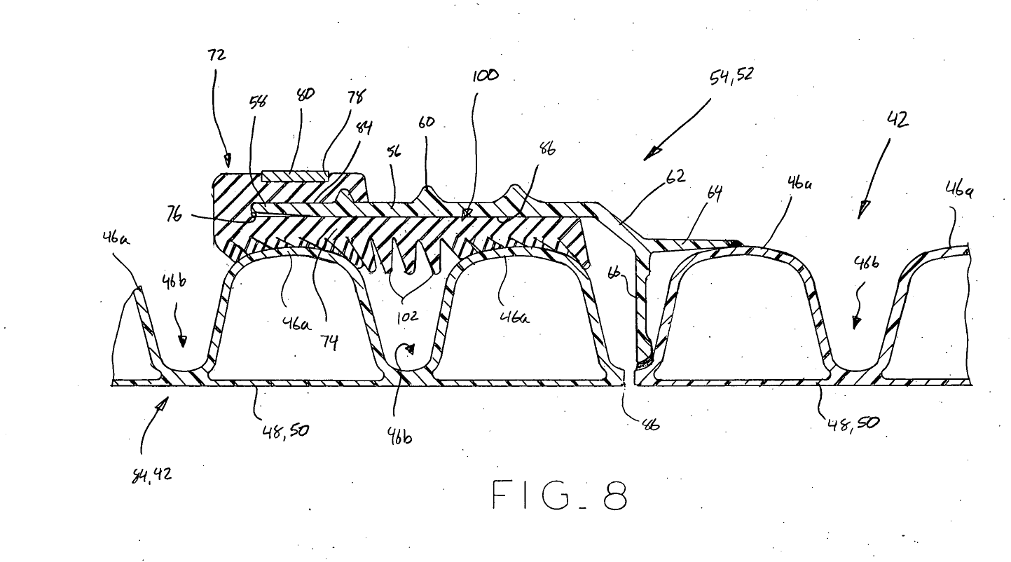

Referring to FIG. 8, upon insertion of the spigot end 84 of a first pipe 42 into bell ring 54 of a second pipe 42 which includes gasket 100, sealing ridges 102 and internal portion 74 are deformingly compressed between corrugations 46 of the first pipe 42 and bell ring 54 to provide a watertight seal between the first and second pipes 42.

Advantageously, sealing projections 82 and sealing ridges 102 of gaskets 70 and 100, respectively, are dimensioned such that same extend a relatively large distance radially into the interior of bell ring 54 and are also readily compressible. Thus, sealing projections 82 and sealing ridges 102 provide a watertight seal upon contact with corrugations of pipes 42 even when pipes 42 and corrugations 46 vary in somewhat in size. Thus, gaskets 70 and 100 are able to provide a watertight seal with pipes 42 even then the dimensional tolerances of pipes 42 and/or corrugations 46 vary from manufacturer to manufacturer, such that gaskets 70 and 100 can effectively seal end-to-end connections between pipes 42 which are produced by different manufacturers. In this manner, the present sealing system allows a contractor to switch between pipes 42 from different pipe manufacturers in the field, greatly increasing the flexibility of pipeline construction and repair.

The present gaskets 70 and 100 also maintain watertight seals between pipes 42 which are connected in an end-to-end manner even if the pipes 42 move with respect to one another, such as by tilting movement of the pipes 42 away from what would otherwise be their common longitudinal axis.

Also, the present gaskets 70 and 100 may be used to easily splice a pipe section into an existing pipeline in which a section of the pipeline has collapsed. For example, the collapsed section of the pipeline could be cut from the pipeline and then removed. Then, a new pipe 42 could be configured with bell rings 54 and gaskets 70 or 100 at each of its ends, followed by sealingly connecting the new pipe 42 between the two cut ends of the pipeline.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A pipe assembly, comprising:
a first pipe section having an end portion including an annular wall with an open end;
an annular gasket positioned over said open end of said annular wall, said gasket comprising:
an external portion disposed on an exterior side of said annular wall, said external portion including at least one clamping band seat; and
an internal portion disposed on an interior side of said annular wall, said internal portion including at least one sealing projection.

2. The pipe assembly of claim 1, wherein said annular wall has an exterior surface and an interior surface, said external portion of said gasket in abutment with said exterior surface and said internal portion of said gasket in abutment with said interior surface.

3. The pipe assembly of claim 1, further comprising an annular clamping band positioned within said clamping band seat around said external portion of said gasket, said external portion of said gasket compressed between said clamping band and said annular wall.

4. The pipe assembly of claim 1, further comprising a second pipe section having an end portion inserted within said annular gasket, said at least one sealing projection of said gasket compressed between said end portion of said second pipe section and said annular wall of said first pipe section.

5. The pipe assembly of claim 4, wherein said end portion of said second pipe section includes a series of corrugations, said at least one sealing projection of said gasket compressed between a peak of at least one said corrugation of said end portion of said second pipe section and said annular wall of said first pipe section.

6. The pipe assembly of claim 1, wherein said first pipe section includes a series of corrugations, and said annular wall comprises an annular bell ring attached to at least one of said corrugations.

7. The pipe assembly of claim 6, wherein said annular bell ring comprises at least two, axially-spaced annular ridges projecting therefrom.

8. The pipe assembly of claim 1, wherein said gasket comprises at least two said sealing projections axially spaced from one another.

9. The pipe assembly of claim 1, wherein said at least one sealing projection comprises a series of sealing ridges projecting radially inwardly from said internal portion of said gasket.

10. A pipe assembly, comprising:
a first pipe section having a plurality of corrugations defining alternating peaks and valleys and an end portion including an annular wall with an open end;
an annular gasket positioned over said open end of said annular wall, said gasket comprising:
an external portion disposed on an exterior side of said annular wall, said external portion including at least one clamping band seat; and
an internal portion disposed on an interior side of said annular wall, said internal portion including at least one sealing projection; and
an annular clamping band positioned within said clamping band seat around said external portion of said gasket, said external portion of said gasket compressed between said clamping band and said annular wall.

11. The pipe assembly of claim 10, wherein said annular wall has an exterior surface and an interior surface, said external portion of said gasket in abutment with said exterior surface and said internal portion of said gasket in abutment with said interior surface.

12. The pipe assembly of claim 10, further comprising a second pipe section having an end portion inserted within said annular gasket, said at least one sealing projection of said gasket compressed between said end portion of said second pipe section and said annular wall of said first pipe section.

13. The pipe assembly of claim 12, wherein said end portion of said second pipe section includes a series of corrugations, said at least one sealing projection of said gasket compressed between a peak of at least one said corrugation of said end portion of said second pipe section and said annular wall of said first pipe section.

14. The pipe assembly of claim 10, wherein said at least one sealing projection comprises a series of sealing ridges projecting radially inwardly from said internal portion of said gasket.

15. In combination:
a first pipe section having an end portion including an annular wall with an open end, and an annular gasket positioned over said open end of said annular wall, said gasket comprising:
an external portion disposed on an exterior side of said annular wall; and
an internal portion disposed on an interior side of said annular wall, said internal portion including at least one sealing projection; and
a second pipe section having an end portion inserted within said annular gasket, said at least one sealing projection of said gasket compressed between said end portion of said second pipe section and said annular wall of said first pipe section.

16. The combination of claim 15, wherein said annular wall has an exterior surface and an interior surface, said external portion of said gasket in abutment with said exterior surface and said internal portion of said gasket in abutment with said interior surface.

17. The combination of claim 15, further comprising an annular clamping band positioned around said external portion of said gasket, said external portion of said gasket compressed between said clamping band and said annular wall.

18. The combination of claim 15, wherein said external portion of said gasket includes at least one clamping band seat, said clamping band positioned within said clamping band seat.

19. The combination of claim 15, wherein said end portion of said second pipe section includes a series of corrugations, said at least one sealing projection of said gasket compressed between a peak of at least one said corrugation of said end portion of said second pipe section and said annular wall of said first pipe section.

20. The combination of claim 15, wherein said at least one sealing projection comprises a series of sealing ridges projecting radially inwardly from said internal portion of said gasket.
